(19) United States
(12) Patent Application Publication
(10) Pub. No.: US 2015/0120238 A1
(43) Pub. Date: Apr. 30, 2015

(54) MONITORING ADJUSTABLE WORKSTATIONS

(71) Applicant: FUJITSU LIMITED, Kawasaki-shi (JP)

(72) Inventors: David L. MARVIT, San Francisco, CA (US); Ajay CHANDER, San Francisco, CA (US); Jawahar JAIN, Los Altos, CA (US); Alex GILMAN, Fremont, CA (US)

(73) Assignee: FUJITSU LIMITED, Kawasaki-shi (JP)

(21) Appl. No.: 14/062,695

(22) Filed: Oct. 24, 2013

(51) Int. Cl. G06F 19/00

(52) U.S. Cl. CPC G06F 19/36
USPC 702/152

(57) ABSTRACT

According to an aspect of an embodiment, a method of monitoring utilization of an adjustable workstation includes automatically tracking a state of the adjustable workstation over time. The method further includes storing the state of the adjustable workstation over time across multiple selected arrangements of the adjustable workstation.

### FIELD

The embodiments discussed herein are related to monitoring adjustable workstations.

### BACKGROUND

Businesses and individuals have become more aware of adverse health effects associated with workplaces. For example, sitting for long periods of time has been recognized as a potentially unhealthy behavior. Workers who spend large portions of their workdays sitting at a workstation such as a desk may experience adverse health effects such as disrupted metabolic functions, back pain, and the like.

Adjustable workstations may attempt to mitigate adverse health effects associated with prolonged sitting by allowing a worker to vary their posture as they work. Examples of adjustable workstations include adjustable desks commonly described as sit-to-stand desks. Sit-to-stand desks may allow a relative height of a work surface of the desk to be selectively varied. A worker using a sit-to-stand desk may vary the height of the work surface to allow the worker to stand, sit, and otherwise vary their posture throughout the workday. Examples of adjustable workstations further include activity-enabling desks commonly described as walkstations. Walkstations incorporate a treadmill and/or other activity-enabling elements into a workstation. A worker using a walkstation may selectively utilize the treadmill and/or other activity-enabling elements and may adjust the rate and/or duration of their walking and/or other activities throughout the workday.

### SUMMARY

According to an aspect of an embodiment, a method of monitoring utilization of an adjustable workstation includes automatically tracking a state of the adjustable workstation over time. The method further includes storing the state of the adjustable workstation over time across multiple selected arrangements of the adjustable workstation.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a diagrammatic view of a system of monitoring utilization of an adjustable workstation;

FIG. 2 is a diagrammatic view of another system of monitoring utilization of an adjustable workstation;

FIG. 3 is a diagrammatic view of yet another system of monitoring utilization of an adjustable workstation; and

FIG. 4 is a flowchart of a method of monitoring utilization of an adjustable workstation.

### DESCRIPTION OF EMBODIMENTS

Employers are increasingly considering supplying adjustable workstations, such as sit-to-stand desks or walkstations, to their employees, often in response to a request by the employee. However, adjustable workstations may be considerably more expensive than conventional, non-adjustable workstations. When considering whether to purchase and install relatively expensive adjustable workstations, employers have little information about whether the adjustable workstations will actually be utilized, how the adjustable workstations will be utilized, and how the adjustable workstations may affect the employees' work habits, activities, and/or productivity.

Embodiments described herein may allow adjustable workstations to be monitored to determine how the adjustable workstations are being utilized. In a manner, the adjustable workstation may be monitored such that the adjustable workstation acts as a sensor of actions and habits of an employee using the adjustable workstation. Information about the utilization of existing adjustable workstations may help employers determine whether to invest in additional adjustable workstations. Furthermore, information about the utilization of adjustable workstations may be used to identify ways to improve employee health, employee productivity, adjustable workstation designs, and the like.

Embodiments of the present invention will be explained with reference to the accompanying drawings.

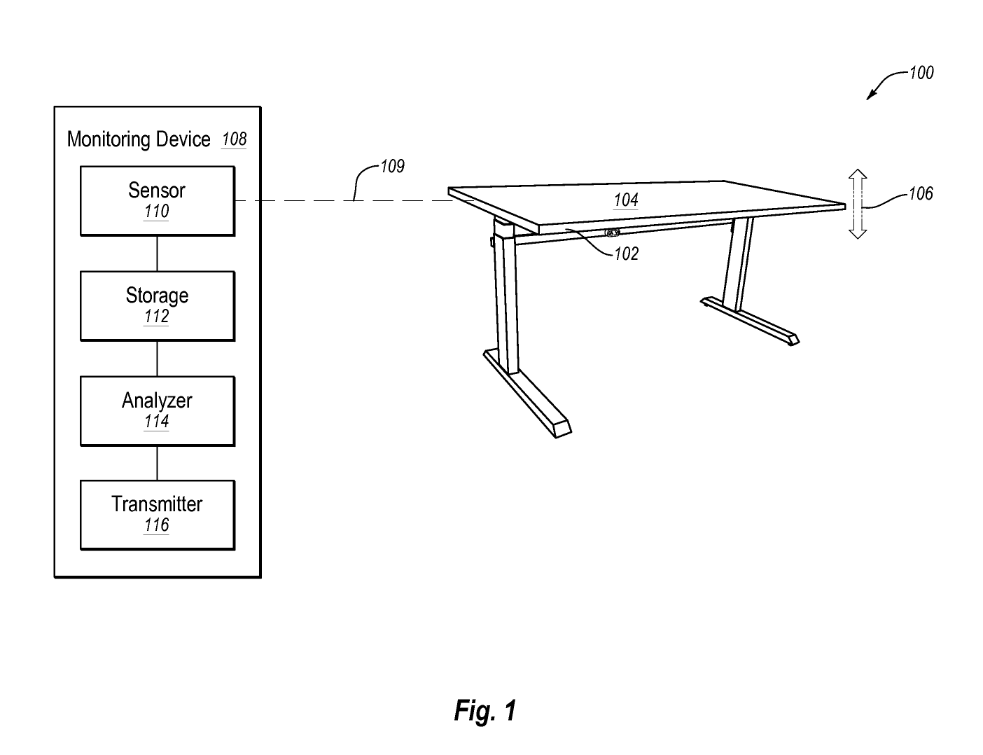

FIG. 1 is a diagrammatic view of a system 100 of monitoring utilization of an adjustable workstation 102. The adjustable workstation 102 may include a work surface 104. Although not shown, the adjustable workstation 102 may include equipment to be used by a user of the adjustable workstation 102. For example, the adjustable workstation 102 may include one or more computing devices, displays, computer input devices, tools, machinery, or the like or any combination thereof.

The adjustable workstation 102 may be selectively arranged by making adjustments 106 to the adjustable workstation 102. For example, adjustments 106 may be made to increase and/or decrease a relative height of the work surface 104. Alternately or additionally, adjustments 106 may be made to operate an activity-enabling element of the adjustable workstation 102, such as turning a treadmill on or off, or changing a rate or incline of the treadmill. Alternately or additionally, the adjustable workstation 102 may be configured to make other types of adjustments 106 such as tilting the work surface 104, moving separate portions of the work surface 104 relative to one another, or the like. A user working at the adjustable workstation 102 may make adjustments 106 to the adjustable workstation 102 to allow the worker to sit, stand, walk, or otherwise vary their posture while at the adjustable workstation 102. Alternately or additionally, adjustments 106 may be made automatically, e.g., by a controller or processor in communication with and/or included in the adjustable workstation.

In some embodiments, the adjustable workstation 102 may include a conventional sit-to-stand desk or a conventional walkstation. Alternately, another type of adjustable workstation 102 may be used. In some embodiments, the adjustable workstation 102 may be a self-monitoring adjustable workstation 102 including instruments for monitoring its utilization according one or more embodiments described herein.

The system 100 may include a monitoring device 108. The monitoring device 108 includes a sensor 110. The sensor 110 and/or the monitoring device 108 may be located on the adjustable workstation 102. Alternately, the sensor 110 and/or the monitoring device 108 may be located off the adjustable workstation 102 and the sensor 110 may be suitably located to sense a state of the adjustable workstation 102, as indicated by line 109.

The sensor 110 automatically tracks a state of the adjustable workstation 102 over time, referred to herein as the tracked state of the adjustable workstation 102. The state of the adjustable workstation 102 may vary over time according to the information sensed by the sensor 110. The sensor 110 may track the state of the adjustable workstation 102 continuously or intermittently.

The sensor 110 may output a signal representing a sensed state of the adjustable workstation 102 and a time the state was sensed. Alternately, the sensor 110 may output a signal representing a sensed state of the adjustable workstation 102 and the signal may be associated with a time the state was sensed external to the sensor 110.

The sensor 110 may include an accelerometer. The accelerometer may be located on the adjustable workstation 102. The accelerometer may measure movement of the adjustable workstation 102. In some embodiments, the accelerometer measures adjustments 106 of the adjustable workstation 102. For example, movements measured by the accelerometer may be integrated to determine placements of the adjustable workstation 102. The determined adjustments 106 may be used to identify arrangements of the adjustable workstation 102 selected by the user of the adjustable workstation 102, referred to herein as selected arrangements of the adjustable workstation 102. Selected arrangements may include selected positions of the adjustable workstation 102, selected operations of an activity-enabling element of the adjustable workstation 102, or the like or any combination thereof.

The accelerometer may alternately or additionally measure transitory movements of the adjustable workstation 102, such as small, temporary movement created while a user is typing, writing, talking, or otherwise performing an activity at the adjustable workstation 102.

Alternately or additionally, the sensor 110 may include a microphone. The microphone may be located on or relatively near the adjustable workstation 102 such that the microphone may sense audible output of the adjustable workstation 102. The microphone may sense audible output made by a user of the adjustable workstation 102, such as sounds of talking, writing, typing, and the like. The microphone may also sense audible output of the adjustable workstation 102, such as sounds of motors used to make adjustments 106 to the adjustable workstation 102. Characteristics of the audible output may indicate the adjustments 106 that are occurring. For example, if the adjustable workstation 102 is being selectively positioned and the velocity of the adjustments 106 is known through the sensor 110 or otherwise, durations of the audible output may be used to measure the adjustments 106 and to determine the selected positions of the adjustable workstation 102.

Alternately or additionally, the sensor 110 may include a range finder. The range finder may be located on the adjustable workstation 102, and in particular on a movable surface or component of the adjustable workstation 102, and may sense a distance between the adjustable workstation 102 and a fixed surface. Alternately, the range finder may be located on a fixed surface and may sense a distance between the fixed surface and the adjustable workstation 102, or more particularly between the fixed surface and a movable surface or component of the adjustable workstation 102. The range finder may measure adjustments 106 of the adjustable workstation 102 by measuring changes in the distance between the fixed surface and the adjustable workstation 102. For example, the sensed distances between the fixed surface and the adjustable workstation 102 may be used to determine the selected positions of the adjustable workstation 102.

Alternately or additionally, the sensor 110 may include an image capturing device. The image capturing device may be positioned to optically sense visual output of the adjustable workstation 102. The image capturing device may optically sense visual output of a user of the adjustable workstation 102, such as movement of the user, user interaction with objects, and the like. The image capturing device may optically sense the selected arrangements of the adjustable workstation 102 and/or adjustments 106 of the adjustable workstation 102. The selected arrangements of the adjustable workstation 102 and/or the adjustments 106 of the adjustable workstation 102 may be determined by optically sensing the adjustable workstation 102 placements and/or movements relative to the environment of the adjustable workstation 102.

Computer vision may be used to sense the visual output of the adjustable workstation 102. For example, computer vision algorithms such as object recognition and movement detection may be used to recognize the adjustable workstation 102 and sense the placements and/or movements of the adjustable workstation 102 at times when adjustments 106 are made to the adjustable workstation 102. In some embodiments, the image capturing device may conserve resources of the monitoring device 108 by outputting frames of captured images when adjustments 106 are being made to the adjustable workstation 102, but may refrain from outputting captured images when adjustments 106 are not being made.

Alternately or additionally, the sensor 110 may include an activity and/or productivity monitor to track activities and/or productivity of a user of the adjustable workstation 102. For example, a computer usage sensor running on a computer (not shown) located at the adjustable workstation 102 may monitor computer activity of the user of the adjustable workstation 102. The computer activity monitored may include keystroke activity, internet browsing activity, or the like. Computer activities monitored by the computer usage sensor may be used in tracking activities and/or productivity of the user of the adjustable workstation 102 over time.

The monitoring device 108 may include a storage 112. The storage 112 stores the tracked state of the adjustable workstation 102. For example, the storage 112 may store sensed states of the adjustable workstation 102 output from the sensor 110, as well as times associated with the sensed states. Alternately or additionally, the storage 112 may store tracked states of the adjustable workstation 102 output from the sensor 110. The storage 112 may include tangible or non-transitory computer-readable storage media.

The storage 112 may store the tracked state of the adjustable workstation 102 across multiple selected arrangements of the adjustable workstation 102. For example, the storage 112 may store the state of the adjustable workstation 102 over a prolonged period of time in which a user of the adjustable workstation 102 has made multiple adjustments such that the user could sit, stand, walk, or otherwise vary their posture while at the adjustable workstation 102. Storing the tracked state of the adjustable workstation 102 across multiple selected arrangements of the adjustable workstation 102 may allow utilization measurements of the adjustable workstation 102 to be determined based on the stored information.

The monitoring device 108 may include an analyzer 114. The analyzer 114 may determine utilization measurements of the adjustable workstation 102. The utilization measurements may be based on the tracked state of the adjustable workstation 102 across multiple selected arrangements of the adjustable workstation 102. In some embodiments, the utilization measurements may be stored in the storage 112.

In some embodiments, the utilization measurements may include aggregates and/or distributions of times that adjustments 106 are made to the adjustable workstation 102, referred to herein as adjustment utilization. The adjustment utilization may include details of how the adjustable workstation 102 is utilized. In some embodiments, the adjustment utilization may be associated with one or more particular users of the adjustable workstation 102. Alternately or additionally, the adjustment utilization may be associated with a particular time period such as a work shift hour, day, week, month, year, or the like.

By way of example, the adjustment utilization may detail how often adjustments 106 are made to the adjustable workstation 102 and the times the adjustments 106 are made. Alternately or additionally, the adjustment utilization may detail which arrangements of the adjustable workstation 102 were selected, how long each selected arrangement was maintained, and the times the arrangements were selected. Alternately or additionally, the adjustment utilization may detail likely postures of the user. For example, the adjustment utilization may detail whether the user is likely sitting, standing, or walking based on the arrangement of the adjustable workstation 102.

In some embodiments, the utilization measurements may include aggregates and/or distributions of times that users performed particular activities at the adjustable workstation 102, referred to herein as activity utilization. The activity utilization may include details of how the user uses the adjustable workstation 102 to perform various activities. The tracked state of the adjustable workstation 102 may be analyzed to determine activities of the user of the adjustable workstation 102. In some embodiments, the types of activities that might be identified from analyzing the tracked state of the adjustable workstation 102 may depend on the types of sensor devices included in the sensor 110, as described in detail above.

Activities of the user may include reading, typing, writing, interacting with a computer via a computer mouse or other input device, conversing with another person via telephone, conversing with another person near the adjustable workstation 102, manufacturing, sleeping, making adjustments 106 to the adjustable workstation 102, and the like. The activity utilization may further determine whether the activity contributes to the productivity of the user. For example, the productivity of the activity may be determined by analyzing the state of the adjustable workstation 102, including analyzing the computer activity of the user of the adjustable workstation 102 sensed by a computer usage sensor, as described above.

The utilization measurements may correlate the activity utilization and the adjustment utilization of the adjustable workstation 102. For example, the utilization measurements may include details of how often and/or for how much time the user undertakes a particular activity in a particular arrangement of the adjustable workstation 102. Alternately or additionally, the utilization measurements may include details of how user activity and/or user productivity correlates with the frequency, size, type, and/or timing of adjustments 106 to the adjustable workstation 102.

The monitoring device 108 may include a transmitter 116. The transmitter 116 may include a wired transmitter 116 such as an optical or Ethernet transmitter 116. Alternately or additionally, the transmitter 116 may include a wireless transmitter 116 such as an IEEE 802.11 or Bluetooth transmitter 116. The transmitter 116 may transmit utilization measurements from the analyzer 114 to a receiver (not shown) of a system configured to collect the utilization measurements. Alternately or additionally, the transmitter 116 may transmit the tracked state of the adjustable workstation 102 from the storage 112. Alternately or additionally, the transmitter 116 may transmit the tracked state of the adjustable workstation 102 from the sensor 110. Alternately or additionally, the transmitter 116 may transmit a raw data signal output by the sensor 110. The transmitter 116 may transmit utilization measurements and/or tracked states of the adjustable workstation 102 to a system configured to collect and/or process such information from multiple adjustable workstations generally corresponding to the adjustable workstation 102.

In some embodiments, the transmitter 116 may transmit utilization measurements and/or the tracked state of the adjustable workstation 102 to a display (not shown). For example, the utilization measurements may be transmitted to the display and displayed to the user of the adjustable workstation 102. Alternately or additionally, the transmitter 116 may transmit utilization measurements and/or the tracked state of the adjustable workstation 102 to a lifestyle monitor of the user of the adjustable workstation 102 such that the utilization measurements and/or the tracked state of the adjustable workstation 102 may be tracked along with other lifestyle information of the user.

The utilization measurements, the tracked state, the raw data signal, and/or other data generated by or stored in one or more of the components 110, 112, 114, 116 of the monitoring device 108 may be further analyzed outside of the monitoring device 108. For example, the data may be further analyzed by a computing device, by a server, by a mobile device, or the like or any combination thereof. In some embodiments, utilization measurements and/or tracked states of multiple adjustable workstations generally corresponding to the adjustable workstation 102 may be collected and analyzed. For example, an employer may collect utilization measurements and/or tracked states of some or all of the adjustable workstations 102 used by its employees.

An employer, researcher, or the like may analyze utilization measurements and/or tracked states of multiple adjustable workstations 102 to determine how adjustable workstations 102 are generally utilized by different users, groups of users, and the like. For example, an employer or researcher may determine aggregates and/or distributions of utilization measurements and/or tracked states of adjustable workstations 102 over groups of employees, such as employees belonging to an organizational department, employees with particular characteristics, and the like. Alternately or additionally, general usage patterns of adjustable workstations 102 may be determined for particular time periods, such as a work shift, day, week, month, year, or the like.

In some embodiments, an employer may analyze utilization measurements and/or tracked states of multiple adjustable workstations 102 to determine individual users and/or groups of users that make adjustments 106 to their adjustable workstation 102 more than or less than threshold amounts. The threshold amounts may be based on an expected and/or an average frequency, size, type, and/or number of adjustments 106 generally made by users of adjustable workstations 102.

Modifications, additions, or omissions may be made to FIG. 1 without departing from the scope of the described embodiments. For example, although only a single sensor 110 is illustrated, in other embodiments the monitoring device 108 may include multiple sensors 110. Alternately or additionally, the adjustable workstation 102 may include one or more components for adjusting the adjustable workstation 102, such as one or more electric or hydraulic motors, or the like.

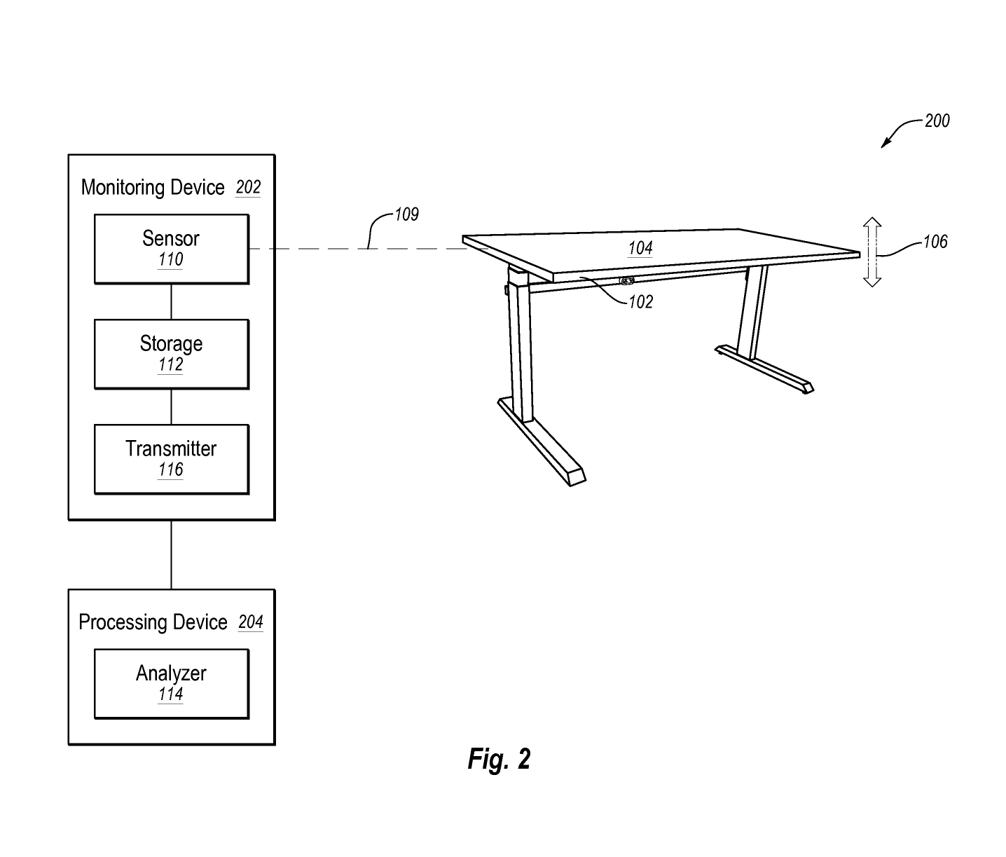

FIG. 2 is a diagrammatic view of another system 200 of monitoring utilization of an adjustable workstation 102. The system 200 includes some elements that are similar or identical to elements of the system 100 of FIG. 1, such as the adjustable workstation 102, the sensor 110, the storage 112, the analyzer 114, and the transmitter 116, for which a more detailed description is already provided above.

The system 200 includes a monitoring device 202. The monitoring device 202 may include the sensor 110, the storage 112, and the transmitter 116. The transmitter 116 may transmit tracked states or other data of the adjustable workstation 102 from the sensor 110 and/or the storage 112. The transmitter 116 may transmit the tracked states to a processing device 204.

The processing device 204 may receive the tracked states of the adjustable workstation 102 from the monitoring device 202. The processing device 204 may include a computing device (not shown) located at the adjustable workstation 102. In some embodiments, the computing device may be the computing device used by a user of the adjustable workstation 102. Alternately or additionally, the processing device 204 may include a system for collecting and analyzing tracked states of multiple adjustable workstations generally corresponding to the adjustable workstation 102. For example, the processing device 204 may include a computer, server, or other system for an employer to collect and analyze tracked states of some or all of the adjustable workstations 102 used by its employees.

The processing device 204 includes the analyzer 114. The analyzer 114 may determine utilization measurements of the adjustable workstation 102, as described in detail above. The analyzer 114 may also analyze utilization measurements and/or tracked states of multiple adjustable workstations 102 to determine how adjustable workstations 102 are generally utilized, as described in detail above.

In some embodiments, the processing device 204 may include a storage (not shown) generally corresponding to the storage 112 for storing the utilization measurements and/or tracked states of the adjustable workstation 102. Alternately or additionally, the processing device 204 may include a transmitter (not shown) generally corresponding to the transmitter 116 for transmitting utilization measurements and/or tracked states of the adjustable workstation 102.

The system 200 may allow the monitoring device 202 to be built without an analyzer 114 and to be used with an existing computer, a dedicated system, or the like as the processing device 204. A monitoring device without an analyzer, such as the monitoring device 202 without the analyzer 114, may be manufactured for a lower cost than an otherwise similar monitoring device including an analyzer, such as the monitoring device 108 including the analyzer 114 of FIG. 1, for example. An employer may be able to monitor multiple adjustable workstations 102 for a lower cost using monitoring devices 202 without analyzers 114.

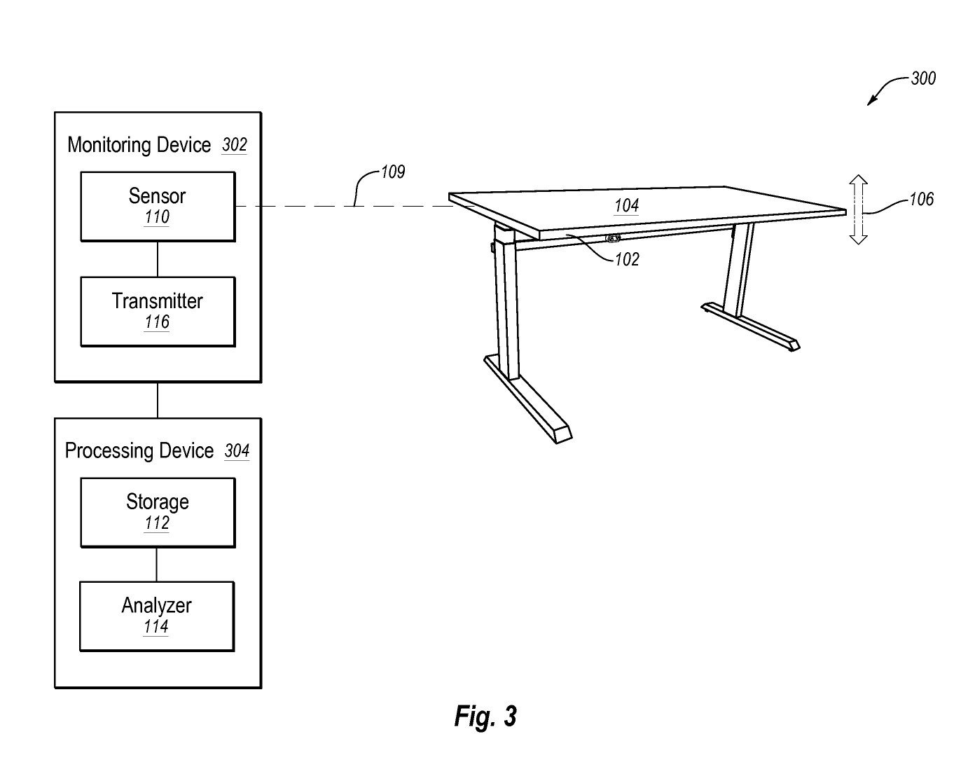

FIG. 3 is a diagrammatic view of yet another system 300 of monitoring utilization of an adjustable workstation 102. The system 300 includes some elements that are similar or identical to elements of the system 100 of FIG. 1 and/or the system 200 of FIG. 2, such as the adjustable workstation 102, the sensor 110, the storage 112, the analyzer 114, and the transmitter 116, for which a more detailed description is already provided above.

The system 300 includes a monitoring device 302. The monitoring device 302 may include the sensor 110 and the transmitter 116. The transmitter 116 may transmit tracked states of the adjustable workstation 102 from the sensor 110 to a processing device 304.

The processing device 304 may receive the tracked states of the adjustable workstation 102 from the monitoring device 302. The processing device 304 may include a computing device (not shown) located at the adjustable workstation 102. In some embodiments, the computing device may be the computing device used by a user of the adjustable workstation 102. Alternately or additionally, the processing device 304 may include a system for collecting and analyzing tracked states of multiple adjustable workstations generally corresponding to the adjustable workstation 102. For example, the processing device 304 may include a computer, server, or other system for an employer to collect, store and analyze tracked states of some or all of the adjustable workstations 102 used by its employees.

The processing device 304 includes the storage 112. The storage 112 may store the tracked states of the adjustable workstation 102, as described in detail above.

The processing device 304 includes the analyzer 114. The analyzer 114 may determine utilization measurements of the adjustable workstation 102 based on tracked states of the adjustable workstation 102, as described in detail above. The analyzer 114 may also analyze utilization measurements and/or tracked states of multiple adjustable workstations 102 to determine how adjustable workstations 102 are generally utilized, as described in detail above. In some embodiments, the processing device 204 may include a transmitter (not shown) generally corresponding to the transmitter 116 for transmitting utilization measurements and/or tracked states of the adjustable workstation 102.

The system 300 may allow the monitoring device 302 to be built without both the storage 112 and the analyzer 114 and to be used with an existing computer, a dedicated system, or the like as the processing device 304. A monitoring device without a storage and an analyzer, such as the monitoring device 302, may be manufactured for a lower cost than a similar monitoring device including a storage 112 and/or an analyzer, such as the monitoring devices 108 and 202. An employer may be able to monitor multiple adjustable workstations 102 for a lower cost using monitoring devices 302 that lack both the storage 112 and the analyzer 114.

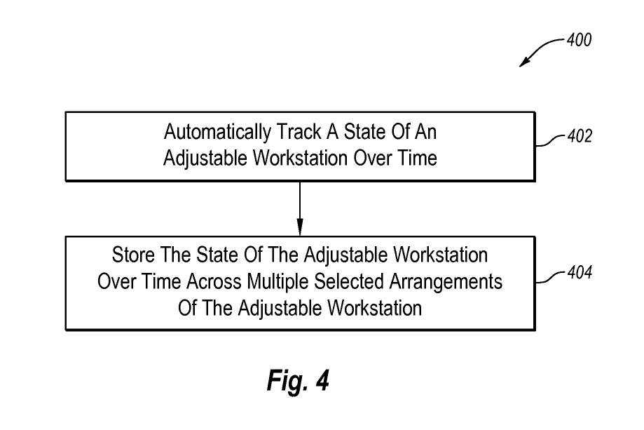

FIG. 4 is a flowchart of a method 400 of monitoring utilization of an adjustable workstation. The adjustable workstation may generally correspond to the adjustable workstation 102 of FIGS. 1-3. The method 400 may be performed, in some embodiments, by a monitoring device, such as the monitoring device 108 of FIG. 1. Alternately, in some embodiments, the method 400 may be performed by a monitoring device and a processing device, such as the monitoring devices 202 and 302 and the processing devices 204 and 304 of FIGS. 2 and 3.

The method 400 may begin at block 402 by automatically tracking a state of an adjustable workstation over time. In some embodiments, automatically tracking a state of an adjustable workstation over time may be performed by a sensor, such as the sensor 110 of FIGS. 1-3. In these and other embodiments, tracking the state of the adjustable workstation over time may include tracking a selected arrangement of the adjustable workstation over time. Alternately or additionally, tracking the state of the adjustable workstation over time may include tracking an activity of a user of the adjustable workstation.

Tracking the state of the adjustable workstation over time may include sensing motion of the adjustable workstation via an accelerometer located on the adjustable workstation. Alternately or additionally, tracking the state of the adjustable workstation over time may include sensing audible output of the adjustable workstation via a microphone. Alternately or additionally, tracking the state of the adjustable workstation over time may include sensing a relative distance of the adjustable workstation from a fixed surface via a range finder. Alternately or additionally, tracking the state of the adjustable workstation over time may include sensing visual output of the adjustable workstation via an image capturing device.

The method 400 may continue at block 404 by storing the state of the adjustable workstation over time across multiple selected arrangements of the adjustable workstation. In some embodiments, storing the state of the adjustable workstation over time across multiple selected arrangements of the adjustable workstation may be performed by a storage, such as the storage 112 of FIGS. 1-3.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For example, in some embodiments, the method 400 may further include transmitting the state of the adjustable workstation over time. In these and other embodiments, transmitting the state of the adjustable workstation over time may be performed by a transmitter, such as the transmitter 116 of FIGS. 1-3.

In some embodiments, the method 400 may include determining a utilization measurement of the adjustable workstation. Determining a utilization measurement of the adjustable workstation may be performed by an analyzer, such as the analyzer 114 of FIGS. 1-3. The utilization measurement may be based at least in part on the state of the adjustable workstation over time. The method 400 may further include transmitting the utilization measurement. Transmitting the utilization measurement may be performed by a transmitter, such as the transmitter 116 of FIGS. 1-3.

The embodiments described herein may include the use of a special purpose or general-purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include tangible and/or non-transitory computer-readable storage media including random-access memory (RAM), read-only memory (ROM), electrically erasable programmable read-only memory (EEPROM), compact disc read-only memory (CD-ROM) or other optical disk storage, magnetic disk storage or other magnetic storage devices, or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions include, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” may refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present inventions have been described in detail, it should be understood that the various changes, substitutions, and alterations could be made hereto without departing from the spirit and scope of the invention.

What is claimed is:

1. A method of monitoring utilization of an adjustable workstation, the method comprising:
automatically tracking a state of the adjustable workstation over time; and
storing the state of the adjustable workstation over time across a plurality of selected arrangements of the adjustable workstation.

2. The method of claim 1, further comprising transmitting the state of the adjustable workstation over time.

3. The method of claim 1, further comprising determining a utilization measurement of the adjustable workstation, the utilization measurement based at least in part on the state of the adjustable workstation over time.

4. The method of claim 3, further comprising transmitting the utilization measurement.

5. The method of claim 1, wherein tracking the state of the adjustable workstation over time includes tracking a selected position of the adjustable workstation over time.

6. The method of claim 1, wherein tracking the state of the adjustable workstation over time includes tracking an activity of a user of the adjustable workstation over time.

7. The method of claim 1, wherein tracking the state of the adjustable workstation over time includes sensing motion of a surface or component of the adjustable workstation.

8. The method of claim 1, wherein tracking the state of the adjustable workstation over time includes sensing audible output of the adjustable workstation.

9. The method of claim 1, wherein tracking the state of the adjustable workstation over time includes sensing a relative distance of a surface or component of the adjustable workstation from a fixed surface.

10. The method of claim 1, wherein tracking the state of the adjustable workstation over time includes optically sensing visual output of the adjustable workstation.

11. A system of monitoring utilization of an adjustable workstation, the system comprising:
a sensor configured to automatically track a state of the adjustable workstation over time; and
a storage configured to store the state of the adjustable workstation over time across a plurality of selected arrangements of the adjustable workstation.

12. The system of claim 11, further comprising a transmitter configured to transmit the state of the adjustable workstation over time.

13. The system of claim 11, further comprising an analyzer configured to determine a utilization measurement of the adjustable workstation, the utilization measurement based at least in part on the state of the adjustable workstation over time.

14. The system of claim 13, further comprising a transmitter configured to transmit the utilization measurement.

15. The system of claim 11, wherein the state of the adjustable workstation includes a selected position of the adjustable workstation.

16. The system of claim 11, wherein the state of the adjustable workstation includes an activity of a user of the adjustable workstation.

17. The system of claim 11, wherein the sensor includes one of:
an accelerometer located on the adjustable workstation, the accelerometer configured to sense motion of the adjustable workstation,
a microphone configured to sense an audible output of the adjustable workstation,
a range finder configured to sense a relative distance of the adjustable workstation from a fixed surface, and
an image capturing device configured to sense a visual output of the adjustable workstation.

18. A self-monitoring adjustable workstation comprising:
a work surface configured to be selectively positioned;
a sensor configured to automatically track a state of the adjustable workstation over time, including a selected position of the work surface;
a storage configured to store the state of the adjustable workstation over time across a plurality of selected positions of the adjustable workstation;
an analyzer configured to determine a utilization measurement of the adjustable workstation, the utilization measurement based at least in part on the state of the adjustable workstation over time; and
a transmitter configured to transmit the utilization measurement.

19. The self-monitoring adjustable workstation of claim 18, wherein the state of the adjustable workstation further includes an activity of a user of the adjustable workstation.

20. The self-monitoring adjustable workstation of claim 18, wherein the sensor includes one of:
an accelerometer located on the adjustable workstation, the accelerometer configured to sense motion of the adjustable workstation,
a microphone configured to sense an audible output of the adjustable workstation,
a range finder configured to sense a relative distance of the adjustable workstation from a fixed surface, and
an image capturing device configured to sense a visual output of the adjustable workstation.
